(19) United States
(12) Patent Application Publication
(10) Pub. No.: US 2026/0187522 A1
(43) Pub. Date: Jul. 2, 2026

(54) SCAFFOLDED MACHINE LEARNING SYSTEM STATE

(71) Applicant: Microsoft Technology Licensing, LLC, Redmond, WA (US)

(72) Inventors: Marc A GOODNER, Kirkland, WA (US); Brian Scott KRABACH, Snohomish, WA (US); Samuel Edward SCHILLACE, Portola Valley, CA (US)

(73) Assignee: Microsoft Technology Licensing, LLC, Redmond, WA (US)

(21) Appl. No.: 19/003,219

(22) Filed: Dec. 27, 2024

(51) Int. Cl. G06N 20/00

(52) U.S. Cl. CPC G06N 20/00

(57) ABSTRACT

A computing system is provided, including one or more memory devices and one or more processing devices. In an initial interaction session, the one or more processing devices execute an initial instance of a scaffolded machine learning (ML) system that interacts with an initial user over a user interface. The scaffolded ML system includes scaffolding code configured to call one or more ML models. The one or more processing devices store, in the one or more memory devices, an ML system state of the scaffolded ML system during the initial interaction session. In each of a plurality of subsequent interaction sessions, the one or more processing devices retrieve the ML system state, initialize a subsequent instance of the scaffolded ML system with the ML system state, and execute the subsequent instance of the scaffolded ML system.

### BACKGROUND

As machine learning (ML) model capabilities have advanced, ML models have been incorporated into an increasing variety of scaffolded ML systems. Scaffolded ML systems incorporate ML models into larger computing processes by programmatically calling one or more ML models to perform specified tasks within those systems. For example, a scaffolded ML system may include one or more generative language models. The semantic modeling and generation capabilities of a generative language model may accordingly be used to perform specific portions of a computational task. Other portions of the computational task are performed by executing other code, potentially including one or more other machine learning models. For example, that code may selectively call machine learning models at specific times or when specific events occur. Scaffolded ML systems may be used in a wide variety of settings, such as technical support, administrative assistance, event scheduling, education, and scientific research.

### SUMMARY

According to one aspect of the present disclosure, a computing system is provided, including one or more memory devices and one or more processing devices. In an initial interaction session, the one or more processing devices are configured to execute an initial instance of a scaffolded machine learning (ML) system that interacts with an initial user over a user interface. The scaffolded ML system includes scaffolding code configured to call one or more ML models. The one or more processing devices are further configured to store, in the one or more memory devices, an ML system state of the scaffolded ML system during the initial interaction session. In each of a plurality of subsequent interaction sessions, the one or more processing devices are further configured to retrieve the ML system state of the scaffolded ML system from the one or more memory devices. In each of the subsequent interaction sessions, the one or more processing devices are further configured to initialize a subsequent instance of the scaffolded ML system with the ML system state and execute the subsequent instance of the scaffolded ML system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including one or more processing devices configured to execute a scaffolded machine learning (ML) system and store an ML system state, according to one example embodiment.

FIG. 2A schematically shows the computing system when the ML system state is stored as a portable file, according to the example of FIG. 1.

FIG. 2B schematically shows the computing system when the one or more processing devices are configured to store a link to the ML system state, according to the example of FIG. 1.

FIG. 2C schematically shows the computing system when session-specific contextual data is used to initialize a subsequent instance of the scaffolded ML system from the ML system state, according to the example of FIG. 1.

FIG. 3 schematically shows the computing system in an example in which an initial interaction session and a plurality of subsequent interaction sessions utilize different scaffolded ML systems, according to the example of FIG. 1.

FIG. 4A shows a flowchart of a method for use with a computing system to replicate an ML system state of a scaffolded ML system, according to the example of FIG. 1.

FIG. 4B shows additional steps of the method of FIG. 4A that may be performed in some examples to preprocess the ML system state.

FIG. 5 shows a flowchart of a method for use with a computing system at which an ML system state of a first scaffolded ML system is used to initialize subsequent instances of a second scaffolded ML system, according to the example of FIG. 3.

FIG. 6 shows a schematic view of an example computing environment in which the computing system of FIG. 1 may be instantiated.

### DETAILED DESCRIPTION

When a user interacts with a scaffolded ML system, that interaction frequently takes the form of a sequence of conversational turns exchanged over a user interface. Over the course of an interaction session, the user provides inputs at the user interface and receives responses from the scaffolded ML system. In addition, the scaffolded ML system may take actions outside the conversational turn sequence, such as adding calendar appointments, sending messages to other users, and generating new documents.

During an interaction session, the scaffolded ML system accumulates an ML system state. This ML system state may, for example, include respective contexts of one or more ML models included in the scaffolded ML system. The ML system state may further include a state of other code included in the scaffolded ML system, such as respective values of one or more variables.

In order for a user to elicit a desired behavior from the scaffolded ML system, that user may have to set up an ML system state that has specific contents. Putting the scaffolded ML system into such an ML system state may involve experimentation on the part of the user, which may be a time-consuming process that occurs over multiple conversational turns. If a user intends to reproduce the elicited behavior in another interaction session, that user may also have to perform the state setup process. Accordingly, scaffolded ML system behaviors may be difficult and time-consuming to reproduce across interaction sessions.

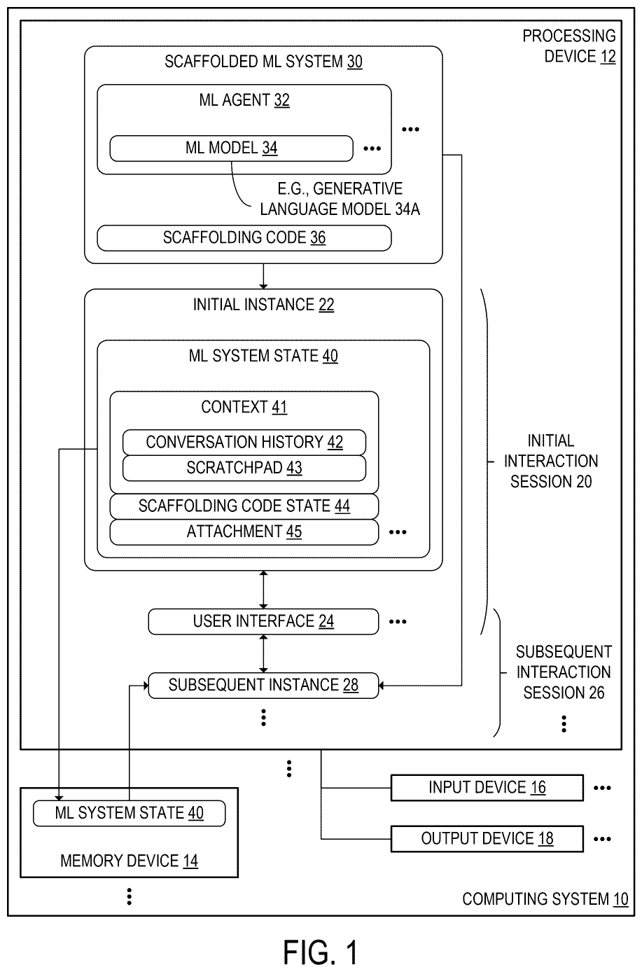

In order to address the above challenges, a computing system 10 is provided, as shown in the example of FIG. 1. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices. In addition, the computing system includes one or more input devices 16 and one or more output devices 18. The one or more input devices 16 and the one or more output devices 18 are used to implement a user interface 24 at which a user interacts with the computing system 10, as discussed in further detail below.

In some examples, the one or more processing devices 12 and/or the one or more memory devices 14 may include a plurality of physical components distributed among a plurality of different physical computing devices. For example, the physical computing devices included in the computing system 10 may have a server-client configuration. In other examples, the computing system 10 may be implemented at a single physical computing device.

The one or more processing devices 12 are configured to instantiate an initial interaction session 20 with an initial user over the user interface 24. In the initial interaction session 20, the one or more processing devices 12 are configured to execute an initial instance 22 of a scaffolded ML system 30 that interacts with the initial user. The scaffolded ML system 30 includes scaffolding code 36 configured to call one or more ML models 34. For example, the one or more ML models 34 may include a generative language model 34A, such as a large language model (LLM) or a large multimodal model (LMM). As other examples, one or more classifier models, image generator models, audio transcription models, and/or other types of ML models 34 may also be included in the scaffolded ML system 30. In some examples, the scaffolded ML system 30 is structured to include a plurality of AI agents 32 that are configured to perform respective categories of computational tasks. The scaffolding code 36, in addition to calling the one or more ML models 34, may be further configured to select the respective inputs of the one or more ML models 34, perform preprocessing on those inputs, and/or perform postprocessing on ML model outputs.

The one or more processing devices 12 are further configured to store, in the one or more memory devices 14, an ML system state 40 of the scaffolded ML system 30 during the initial interaction session 20. The ML system state 40 may include a context 41 of at least one of the one or more ML models 34 included in the scaffolded ML system 30. For example, when the at least one ML model 34 is a generative language model 34A, the context 41 may include a conversation history 42 of the initial user with the generative language model 34A. Additionally or alternatively, the context 41 may include a scratchpad 43 of the generative language model 34A, such as in examples in which the generative language model is configured to use chain-of-thought when generating responses.

In some examples, the ML system state 40 further includes a scaffolding code state 44 of the first scaffolding code 36 during the initial interaction session 20. The scaffolding code state 44 may, for example, include respective values of one or more variables included in the scaffolding code 36, such as variables that indicate which AI agents 32 are activated, or what preprocessing/postprocessing operations the scaffolding code 36 is configured to perform.

In some examples, when interacting with the scaffolded ML system 30 during the initial interaction session 20, the initial user may upload one or more attachments 45 to the scaffolded ML system 30. For example, the user may upload a text document and provide instructions for the scaffolded ML system 30 to summarize or rewrite that document. In examples in which the user uploads one or more attachments 45, the ML system state 40 may include the one or more attachments 45 received during the initial interaction session 20.

The one or more processing devices 12 are further configured to execute a plurality of subsequent interaction sessions 26. These subsequent interaction sessions 26 may be interaction sessions with the initial user and/or with one or more other users of the scaffolded ML system 30. In each of the subsequent interaction sessions 26, the one or more processing devices 12 are further configured to retrieve the ML system state 40 of the scaffolded ML system 30 from the one or more memory devices 14. In each of the subsequent interaction sessions 26, the one or more processing devices 12 are further configured to initialize a respective subsequent instance 28 of the scaffolded ML system 30 with the ML system state 40. The one or more processing devices 12 are further configured to execute the subsequent instance 28 of the scaffolded ML system 30 in each of those subsequent interaction sessions 26. Thus, the one or more processing devices 12 are configured to replicate the ML system state 40 reached in the initial interaction session 20 and instantiate the scaffolded ML system 30 with that ML system state 40 in the plurality of subsequent interaction sessions 26.

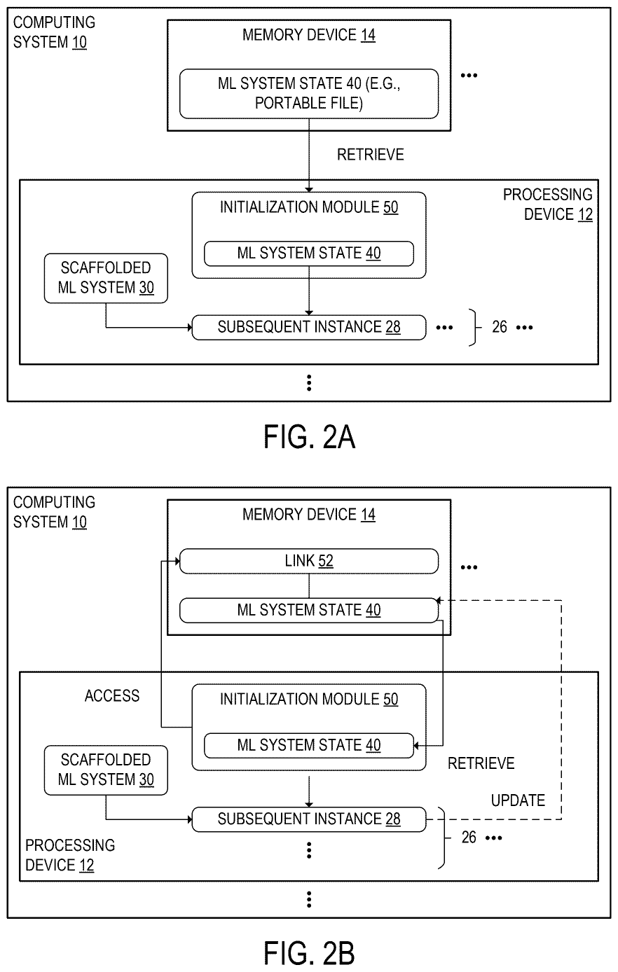

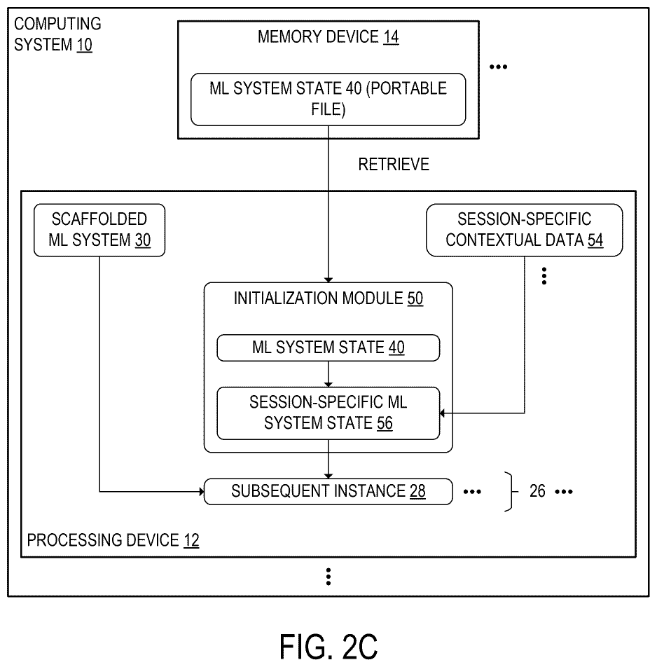

FIGS. 2A-2C show the computing system 10 in corresponding examples when the one or more processing devices 12 retrieve the ML system state 40 from the one or more memory devices 14. As shown in the example of FIG. 2A, when the one or more processing devices 12 store the ML system state 40 in the one or more memory devices 14, the one or more processing devices 12 may be configured to store the ML system state 40 as a portable file. The one or more processing devices 12 may be further configured to execute an initialization module 50 that retrieves copies of the portable file from the one or more memory devices 14 and loads those copies into the subsequent instances 28 of the scaffolded ML system 30.

As shown in the example of FIG. 2B, the one or more processing devices 12 may be configured to store a link 52 to the ML system state 40. The one or more processing devices 12 may be further configured to retrieve the ML system state 40 at least in part by accessing the link 52. For example, the link 52 may be a hyperlink to a location in a filesystem or a computer network.

In the example of FIG. 2B, the specific ML system state 40 indicated by the link 52 may be updated during at least one of the subsequent interaction sessions 26. In such examples, when another subsequent instance 28 of the scaffolded ML system 30 retrieves the ML system state 40 after the update is performed, that subsequent instance 28 may retrieve the updated version of the ML system state 40. Thus, the link 52 may point to the current version of the ML system state 40 rather than to an exact copy of the ML system state 40 computed in the initial interaction session 20.

FIG. 2C shows another example of subsequent interaction session initialization in an example in which the ML system state 40 is stored as a portable file. In the example of FIG. 2C, prior to executing a subsequent instance 28 of the plurality of subsequent instances 28, the one or more processing devices 12 are further configured to receive session-specific contextual data 54 associated with the subsequent interaction session 26. For example, the session-specific contextual data 54 may include user profile data of a user who initiates the subsequent interaction session 26. As another example, the session-specific contextual data 54 may include a time at which the subsequent interaction session 26 occurs.

In the example of FIG. 2C, the one or more processing devices 12 are further configured to modify the ML system state 40 based at least in part on the session-specific contextual data 54 to obtain a session-specific ML system state 56. The one or more processing devices 12 are further configured to execute the subsequent interaction session 26 starting from the session-specific ML system state 56. Accordingly, the subsequent instance 28 of the scaffolded ML system 30 is executed in a manner that utilizes additional, session-specific contextual data 54 to guide its interaction with the user.

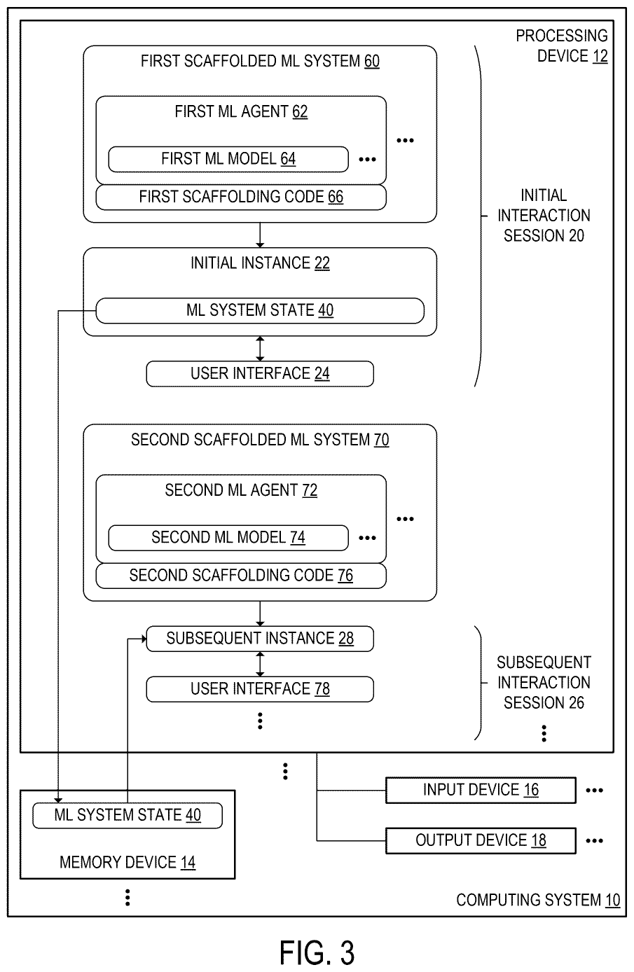

In some examples, as shown in FIG. 3, the initial interaction session 20 and the subsequent interaction session 26 may utilize different scaffolded ML systems. In the example of FIG. 3, the one or more processing devices 12 are configured to execute an initial instance 22 of a first scaffolded ML system 60 in the initial interaction session 20. The first scaffolded ML system interacts with an initial user over a user interface 24. The first scaffolded ML system 60 includes first scaffolding code 66 configured to call one or more first ML models 64. For example, the one or more first ML models 64 may be included in a plurality of first ML agents 62.

The one or more processing devices 12 are further configured to store, in the one or more memory devices 14, an ML system state 40 of the first scaffolded ML system 60 during the initial interaction session 20. For example, as discussed above with reference to FIG. 1, the ML system state 40 may include a context 41 of at least one of the one or more first ML models 64. The context 41 may, for example, include a conversation history 42 and/or a scratchpad 43 in examples in which the one or more first ML models 64 include a generative language model. The ML system state 40 may additionally or alternatively include a scaffolding code state 44 of the first scaffolding code 66, and/or one or more attachments 45 received at the first scaffolded ML system 60 during the initial interaction session 20.

In each of a plurality of subsequent interaction sessions 26, the one or more processing devices 12 are further configured to retrieve the ML system state 40 of the first scaffolded ML system 60 from the one or more memory devices 14. The one or more processing devices 12 are further configured to initialize a subsequent instance 28 of a second scaffolded ML system 70 with the ML system state 40. The second scaffolded ML system 70 includes second scaffolding code 76 configured to call one or more second ML models 74. For example, the one or more second ML models 74 may be included in a plurality of second ML agents 72. The one or more processing devices 12 are further configured to execute the subsequent instance 28 of the second scaffolded ML system 70.

The second scaffolded ML system 70 differs from the first scaffolded ML system 60. For example, the set of one or more first ML models 64 may differ from the set of second ML models 74. Additionally or alternatively, the second scaffolding code 76 may differ from the first scaffolding code 66. In one example, an update to the first scaffolded ML system 60 may be performed between the initial interaction session 20 and one or more of the subsequent interaction sessions 26, to thereby obtain the second scaffolded ML system 70. As another example, the first scaffolded ML system 60 may be a legacy system with which the second scaffolded ML system 70 is backward-compatible.

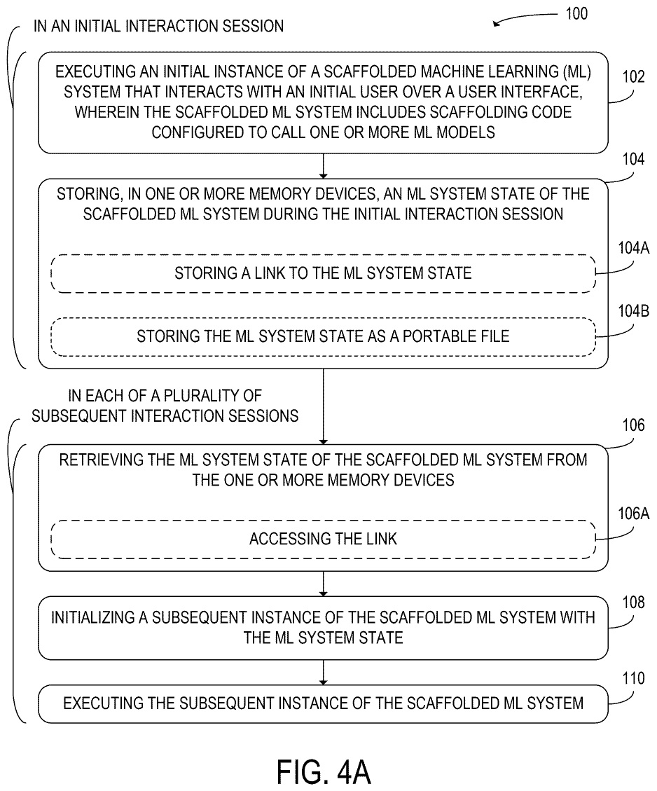

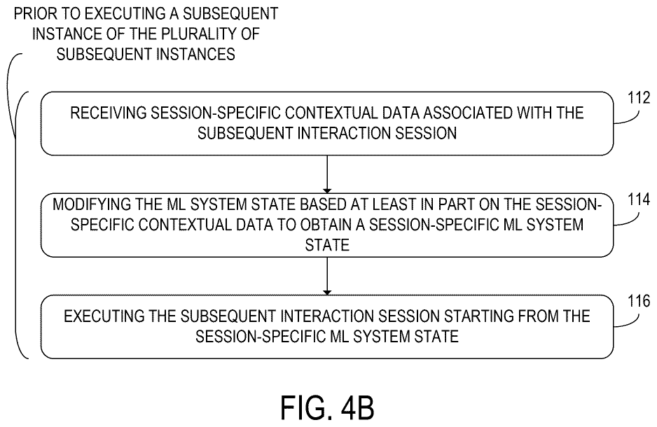

FIG. 4A shows a flowchart of a method 100 for use with a computing system to replicate an ML system state of a scaffolded ML system. Steps 102 and 104 of the method are performed in an initial interaction session. At step 102, the method 100 includes executing an initial instance of a scaffolded ML system that interacts with an initial user over a user interface. The scaffolded ML system includes scaffolding code configured to call one or more ML models.

At step 104, the method 100 further includes storing, in one or more memory devices, an ML system state of the scaffolded ML system. The ML system state is a state the scaffolded ML system has during the initial interaction session. For example, the ML system state may include a context of at least one of the one or more ML models included in the scaffolded ML system. In some examples, the one or more ML models include a generative language model. In such examples, the context may include a conversation history of the initial user with the generative language model and may additionally or alternatively include a scratchpad of the generative language model. The ML system state may additionally or alternatively include a scaffolding code state of the scaffolding code, and/or one or more attachments received at the scaffolded ML system during the initial interaction session.

In some examples, at step 104A, step 104 may further include storing a link to the ML system state. The link may be a hyperlink to a location in a filesystem or a computer network. Additionally or alternatively, at step 104B, step 104 may further include storing the ML system state as a portable file.

Steps 106, 108, and 110 are performed in each of a plurality of subsequent interaction sessions. In some examples, at least one of the subsequent interaction sessions is performed by a different user and/or at a different physical computing device compared to the initial interaction session. At step 106, the method 100 further includes retrieving the ML system state of the scaffolded ML system from the one or more memory devices. In examples in which step 104A is performed, step 106 may, at step 106A, include accessing the link. In examples in which step 104B is performed, step 106 may include retrieving a copy of the portable file.

At step 108, the method 100 further includes initializing a subsequent instance of the scaffolded ML system with the ML system state. In some examples, the subsequent instance is initialized with an exact copy of the ML system state, whereas in other examples, preprocessing is also performed on the ML system state. At step 110, subsequently to initializing the subsequent instance, the method 100 further includes executing the subsequent instance of the scaffolded ML system.

FIG. 4B shows additional steps of the method 100 that may be performed in some examples to preprocess the ML system state prior to executing a subsequent instance of the plurality of subsequent instances. At step 112, the method 100 may further include receiving session-specific contextual data associated with the subsequent interaction session. For example, the session-specific contextual data may include user profile data of a user who initiates the subsequent interaction session. As other examples, the session-specific contextual data may include the time at which the user initiates the subsequent interaction session, and/or one or more hardware properties of a computing device used in the subsequent interaction session.

At step 114, the method 100 may further include modifying the ML system state based at least in part on the session-specific contextual data to obtain a session-specific ML system state. For example, the session-specific contextual data may be added as an attachment to the ML system state or added to a prompt of a generative language model included in the scaffolded ML system. At step 116, the method 100 may further include executing the subsequent interaction session starting from the session-specific ML system state. Thus, in the example of FIG. 4B, the scaffolded ML system utilizes additional session-specific data to guide its interaction with the user.

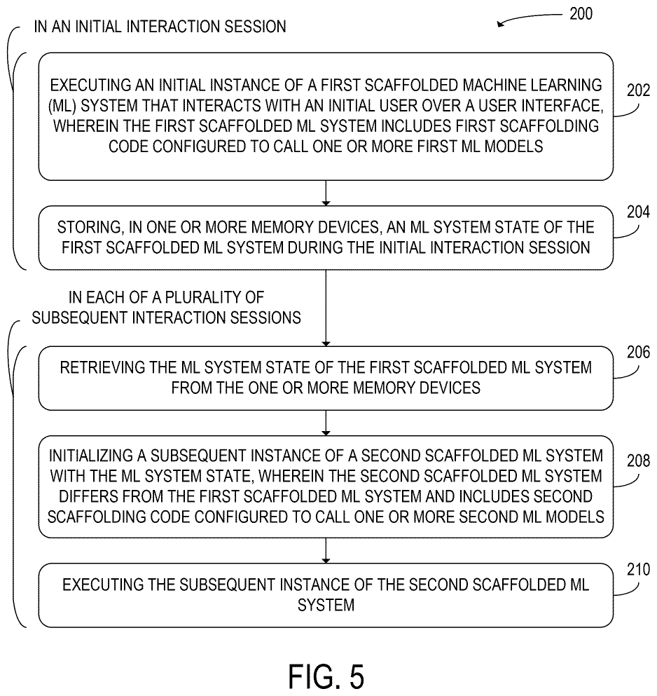

FIG. 5 shows a flowchart of another example method 200 for use with a computing system. Steps 202 and 204 of the method 200 are performed in an initial interaction session. At step 202, the method 200 includes executing an initial instance of a first scaffolded ML system that interacts with an initial user over a user interface. The first scaffolded ML system includes first scaffolding code configured to call one or more first ML models.

At step 204, the method 200 further includes storing, in one or more memory devices, an ML system state of the first scaffolded ML system during the initial interaction session. The ML system state may include the ML system state components discussed above, such as a context, a scaffolding code state, and/or one or more attachments. In examples in which the ML system state includes a context, that context may include a conversation history and/or a scratchpad. The ML system state may be stored as a portable file. Additionally or alternatively, a link to the ML system state may be stored in the one or more memory devices.

Steps 206, 208, and 210 are performed in each of a plurality of subsequent interaction sessions. The subsequent interaction sessions are implemented over one or more user interfaces. At step 206, the method 200 further includes retrieving the ML system state of the first scaffolded ML system from the one or more memory devices. Step 206 may include accessing a link to the ML system state and/or retrieving a copy of the ML system state stored as a portable file.

At step 208, the method 200 further includes initializing a subsequent instance of a second scaffolded ML system with the ML system state. The second scaffolded ML system differs from the first scaffolded ML system and includes second scaffolding code configured to call one or more second ML models. The second scaffolded ML system may differ from the first scaffolded ML system in terms of the ML models it includes and/or in terms of scaffolding code. At step 210, the method 200 further includes executing the subsequent instance of the second scaffolded ML system.

Using the systems and methods discussed above, the state of a scaffolded ML system is stored for later use and is replicated across multiple subsequent interaction sessions. These systems and methods allow an initial user to construct an ML system state that reliably elicits a specific intended pattern of interaction from the scaffolded ML system. The above systems and methods therefore extend prompt engineering to scaffolded ML systems, allowing the initial user to define, curate, and replicate other portions of the ML system state in addition to the context of an ML model.

In one example use case scenario, the scaffolded ML system is configured to perform patient intake in a medical setting. In this example, during the initial interaction session, the initial user prepares a guided conversation state that guides a patient through the process of filling out an intake form. The ML system state, in this example, includes a prompt of a generative language model that is configured to generate text outputs when interacting with patients. In addition, the ML system state includes an indication, in the scaffolding code, that a form-filling agent and a medical agent are activated. By storing and reusing the ML system state, the scaffolded ML system is configured to guide new patients through the intake process in a consistent manner. Saving and retrieving the ML system state allows the computing system to avoid having to newly determine which agents to activate each time a new patient goes through the intake process.

The methods and processes described herein are tied to a computing system of one or more computing devices. In particular, such methods and processes can be implemented as a computer-application program or service, an application-programming interface (API), a library, and/or other computer-program product.

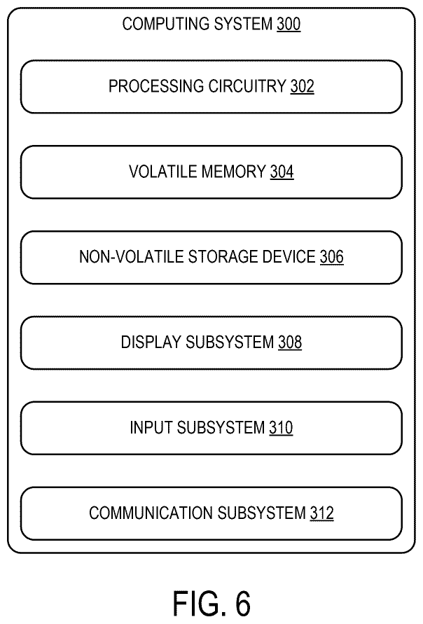

FIG. 6 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more memory devices. The computing system further includes one or more processing devices configured to, in an initial interaction session, execute an initial instance of a scaffolded machine learning (ML) system that interacts with an initial user over a user interface. The scaffolded ML system includes scaffolding code configured to call one or more ML models. The one or more processing devices are further configured to store, in the one or more memory devices, an ML system state of the scaffolded ML system during the initial interaction session. In each of a plurality of subsequent interaction sessions, the one or more processing devices are further configured to retrieve the ML system state of the scaffolded ML system from the one or more memory devices. The one or more processing devices are further configured to initialize a subsequent instance of the scaffolded ML system with the ML system state. The one or more processing devices are further configured to execute the subsequent instance of the scaffolded ML system. The above features may have the technical effect of replicating the ML system state from the initial interaction session to the subsequent interaction sessions.

According to this aspect, the one or more processing devices may be configured to store a link to the ML system state. The one or more processing devices may be further configured to retrieve the ML system state at least in part by accessing the link. The above features may have the technical effect of using the link to point to a current version of the ML system state.

According to this aspect, the one or more processing devices may be configured to store the ML system state as a portable file. The above features may have the technical effect of allowing the ML system state to be exported to other computing devices.

According to this aspect, the ML system state may include a context of at least one of the one or more ML models included in the scaffolded ML system. The above features may have the technical effect of replicating an input of the at least one ML model.

According to this aspect, the one or more ML models may include a generative language model. The context may include a conversation history of the initial user with the generative language model. The above features may have the technical effect of replicating the conversation history from the initial interaction session to the subsequent interaction sessions.

According to this aspect, the one or more ML models may include a generative language model. The context may include a scratchpad of the generative language model. The above features may have the technical effect of replicating the scratchpad from the initial interaction session to the subsequent interaction sessions.

According to this aspect, the ML system state may include a scaffolding code state of the scaffolding code. The above features may have the technical effect of replicating the scaffolding code state from the initial interaction session to the subsequent interaction sessions.

According to this aspect, the ML system state may include one or more attachments received at the scaffolded ML system during the initial interaction session. The above features may have the technical effect of replicating the one or more attachments from the initial interaction session to the subsequent interaction sessions.

According to this aspect, prior to executing a subsequent instance of the plurality of subsequent instances, the one or more processing devices may be further configured to receive session-specific contextual data associated with the subsequent interaction session. The one or more processing devices may be further configured to modify the ML system state based at least in part on the session-specific contextual data to obtain a session-specific ML system state. The one or more processing devices may be further configured to execute the subsequent interaction session starting from the session-specific ML system state. The above features may have the technical effect of adjusting the ML system state to account for properties of the subsequent interaction sessions.

According to another aspect of the present disclosure, a computing system is provided, including one or more memory devices and one or more processing devices. The one or more processing devices are configured to, in an initial interaction session, execute an initial instance of a first scaffolded machine learning (ML) system that interacts with an initial user over a user interface. The first scaffolded ML system includes first scaffolding code configured to call one or more first ML models. The one or more processing devices are further configured to store, in the one or more memory devices, an ML system state of the first scaffolded ML system during the initial interaction session. In each of a plurality of subsequent interaction sessions, the one or more processing devices are further configured to retrieve the ML system state of the first scaffolded ML system from the one or more memory devices. The one or more processing devices are further configured to initialize a subsequent instance of a second scaffolded ML system with the ML system state. The second scaffolded ML system differs from the first scaffolded ML system and includes second scaffolding code configured to call one or more second ML models. The one or more processing devices are further configured to execute the subsequent instance of the second scaffolded ML system. The above features may have the technical effect of replicating the ML system state from the initial interaction session to the subsequent interaction sessions, and between different scaffolded ML systems.

According to this aspect, the one or more processing devices may be configured to store the ML system state as a portable file. The above features may have the technical effect of allowing the ML system state to be exported to other computing devices.

According to this aspect, the ML system state includes a context of at least one of the one or more first ML models. The above features may have the technical effect of replicating an input of the at least one ML model.

According to this aspect, the one or more first ML models may include a generative language model. The context may include a conversation history of the initial user with the generative language model. The above features may have the technical effect of replicating the conversation history from the initial interaction session to the subsequent interaction sessions.

According to this aspect, the one or more first ML models may include a generative language model. The context may include a scratchpad of the generative language model. The above features may have the technical effect of replicating the scratchpad from the initial interaction session to the subsequent interaction sessions.

According to this aspect, the ML system state includes a scaffolding code state of the first scaffolding code. The above features may have the technical effect of replicating the scaffolding code state from the initial interaction session to the subsequent interaction sessions.

According to this aspect, the ML system state may include one or more attachments received at the first scaffolded ML system during the initial interaction session. The above features may have the technical effect of replicating the one or more attachments from the initial interaction session to the subsequent interaction sessions.

According to another aspect of the present disclosure, a method for use with a computing system is provided. The method includes, in an initial interaction session, executing an initial instance of a scaffolded machine learning (ML) system that interacts with an initial user over a user interface. The scaffolded ML system includes scaffolding code configured to call one or more ML models. The method further includes storing, in one or more memory devices, an ML system state of the scaffolded ML system during the initial interaction session. In each of a plurality of subsequent interaction sessions, the method further includes retrieving the ML system state of the scaffolded ML system from the one or more memory devices. The method further includes initializing a subsequent instance of the scaffolded ML system with the ML system state. The method further includes executing the subsequent instance of the scaffolded ML system. The above features may have the technical effect of replicating the ML system state from the initial interaction session to the subsequent interaction sessions.

According to this aspect, the ML system state may include a context of at least one of the one or more ML models included in the scaffolded ML system. The above features may have the technical effect of replicating an input of the at least one ML model.

According to this aspect, the ML system state may include a scaffolding code state of the scaffolding code. The above features may have the technical effect of replicating the scaffolding code state from the initial interaction session to the subsequent interaction sessions.

According to this aspect, the ML system state may include one or more attachments received at the scaffolded ML system during the initial interaction session. The above features may have the technical effect of replicating the one or more attachments from the initial interaction session to the subsequent interaction sessions.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more memory devices; and
one or more processing devices configured to:
in an initial interaction session:
execute an initial instance of a scaffolded machine learning (ML) system that interacts with an initial user over a user interface, wherein the scaffolded ML system includes scaffolding code configured to call one or more ML models; and
store, in the one or more memory devices, an ML system state of the scaffolded ML system during the initial interaction session; and
in each of a plurality of subsequent interaction sessions:
retrieve the ML system state of the scaffolded ML system from the one or more memory devices;
initialize a subsequent instance of the scaffolded ML system with the ML system state; and
execute the subsequent instance of the scaffolded ML system.

2. The computing system of claim 1, wherein the one or more processing devices are configured to:
store a link to the ML system state; and
retrieve the ML system state at least in part by accessing the link.

3. The computing system of claim 1, wherein the one or more processing devices are configured to store the ML system state as a portable file.

4. The computing system of claim 1, wherein the ML system state includes a context of at least one of the one or more ML models included in the scaffolded ML system.

5. The computing system of claim 4, wherein:
the one or more ML models include a generative language model; and
the context includes a conversation history of the initial user with the generative language model.

6. The computing system of claim 4, wherein:
the one or more ML models include a generative language model; and
the context includes a scratchpad of the generative language model.

7. The computing system of claim 1, wherein the ML system state includes a scaffolding code state of the scaffolding code.

8. The computing system of claim 1, wherein the ML system state includes one or more attachments received at the scaffolded ML system during the initial interaction session.

9. The computing system of claim 1, wherein, prior to executing a subsequent instance of the plurality of subsequent instances, the one or more processing devices are further configured to:
receive session-specific contextual data associated with the subsequent interaction session;
modify the ML system state based at least in part on the session-specific contextual data to obtain a session-specific ML system state; and
execute the subsequent interaction session starting from the session-specific ML system state.

10. A computing system comprising:
one or more memory devices; and
one or more processing devices configured to:
in an initial interaction session:
execute an initial instance of a first scaffolded machine learning (ML) system that interacts with an initial user over a user interface, wherein the first scaffolded ML system includes first scaffolding code configured to call one or more first ML models; and
store, in the one or more memory devices, an ML system state of the first scaffolded ML system during the initial interaction session; and
in each of a plurality of subsequent interaction sessions:
retrieve the ML system state of the first scaffolded ML system from the one or more memory devices;
initialize a subsequent instance of a second scaffolded ML system with the ML system state, wherein the second scaffolded ML system differs from the first scaffolded ML system and includes second scaffolding code configured to call one or more second ML models; and
execute the subsequent instance of the second scaffolded ML system.

11. The computing system of claim 10, wherein the one or more processing devices are configured to store the ML system state as a portable file.

12. The computing system of claim 10, wherein the ML system state includes a context of at least one of the one or more first ML models.

13. The computing system of claim 12, wherein:
the one or more first ML models include a generative language model; and
the context includes a conversation history of the initial user with the generative language model.

14. The computing system of claim 12, wherein:
the one or more first ML models include a generative language model; and
the context includes a scratchpad of the generative language model.

15. The computing system of claim 10, wherein the ML system state includes a scaffolding code state of the first scaffolding code.

16. The computing system of claim 10, wherein the ML system state includes one or more attachments received at the first scaffolded ML system during the initial interaction session.

17. A method for use with a computing system, the method comprising:
in an initial interaction session:
executing an initial instance of a scaffolded machine learning (ML) system that interacts with an initial user over a user interface, wherein the scaffolded ML system includes scaffolding code configured to call one or more ML models; and
storing, in one or more memory devices, an ML system state of the scaffolded ML system during the initial interaction session; and
in each of a plurality of subsequent interaction sessions:
retrieving the ML system state of the scaffolded ML system from the one or more memory devices;
initializing a subsequent instance of the scaffolded ML system with the ML system state; and
executing the subsequent instance of the scaffolded ML system.

18. The method of claim 17, wherein the ML system state includes a context of at least one of the one or more ML models included in the scaffolded ML system.

19. The method of claim 17, wherein the ML system state includes a scaffolding code state of the scaffolding code.

20. The method of claim 17, wherein the ML system state includes one or more attachments received at the scaffolded ML system during the initial interaction session.
